(19) United States
(12) Patent Application Publication
(10) Pub. No.: US 2021/0250881 A1
(43) Pub. Date: Aug. 12, 2021

(54) METHOD AND TERMINAL FOR TRANSMITTING SIDELINK CHANNEL/SIGNAL IN WIRELESS COMMUNICATION SYSTEM

(71) Applicant: LG ELECTRONICS INC., Seoul (KR)

(72) Inventors: Seungmin LEE, Seoul (KR); Hyukjin CHAE, Seoul (KR)

(21) Appl. No.: 17/054,138

(22) PCT Filed: May 9, 2019
(86) PCT No.: PCT/KR2019/095010

§ 371 Date: Nov. 9, 2020

(30) Foreign Application Priority Data
May 10, 2018 (KR) 10-2018-0053977

(51) Int. Cl. H04W 56/00; H04W 72/12; H04W 72/04

(52) U.S. Cl. CPC H04W 56/001; H04W 72/0406; H04W 72/1278

(57) ABSTRACT

A method for transmitting a sidelink synchronization signal by a terminal in a wireless communication system, according to one embodiment of the present invention, comprises the steps of: selecting a synchronization carrier and a synchronization criterion; and transmitting the sidelink synchronization signal on the basis of the synchronization carrier, wherein, when the synchronization criterion is a base station or a global navigation satellite system (GNSS), the terminal selects the synchronization carrier from a carrier for transmission of a physical sidelink control channel (PSCCH) or a carrier for transmission of a physical sidelink shared channel (PSSCH).

### TECHNICAL FIELD

The present disclosure relates to a wireless communication system, and more particularly, to a method and a user equipment (UE) for transmitting a sidelink channel/signal.

### BACKGROUND ART

As more and more communication devices demand larger communication capacities, the need for enhanced mobile broadband communication relative to the legacy radio access technologies (RATs) has emerged. Massive machine type communication (mMTC) that provides various services by interconnecting multiple devices and things irrespective of time and place is also one of main issues to be addressed for future-generation communications. A communication system design considering services/user equipments (UEs) sensitive to reliability and latency is under discussion as well. As such, the introduction of a future-generation RAT considering enhanced mobile broadband (eMBB), mMTC, ultra-reliability and low latency communication (URLLC), and so on is being discussed. For convenience, this technology is referred to as new RAT (NR) in the present disclosure. NR is an exemplary 5th generation (5G) RAT.

A new RAT system including NR adopts orthogonal frequency division multiplexing (OFDM) or a similar transmission scheme. The new RAT system may use OFDM parameters different from long term evolution (LTE) OFDM parameters. Further, the new RAT system may have a larger system bandwidth (e.g., 100 MHz), while following the legacy LTE/LTE-advanced (LTE-A) numerology. Further, one cell may support a plurality of numerologies in the new RAT system. That is, UEs operating with different numerologies may co-exist within one cell.

Vehicle-to-everything (V2X) is a communication technology of exchanging information between a vehicle and another vehicle, a pedestrian, or infrastructure. V2X may cover four types of communications such as vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

### DISCLOSURE

### Technical Problem

An aspect of the present disclosure is to provide a method of transmitting a sidelink channel/signal, when a synchronization reference for carrier aggregation (CA) in direct user equipment (UE)-to-UE communication is a base station (BS) or a global navigation satellite system (GNSS).

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, a method of transmitting a sidelink synchronization signal by a user equipment (UE) in a wireless communication system includes selecting a synchronization carrier and a synchronization reference, and transmitting a sidelink synchronization signal based on the synchronization carrier. When the synchronization reference is a base station (BS) or a global navigation satellite system (GNSS), the UE selects the synchronization carrier between a carrier for physical sidelink control channel (PSCCH) transmission and a carrier for physical sidelink shared channel (PSSCH) transmission.

The selection of a synchronization carrier and a synchronization reference may include selecting the synchronization carrier from among a plurality of carriers for PSCCH transmission or a plurality of carriers for PSSCH transmission by the UE, randomly or according to implementation of the UE.

The selection of a synchronization carrier and a synchronization reference may include selecting the synchronization carrier between the carrier for PSCCH transmission and the carrier for PSSCH transmission by the UE, based on at least one combination of a plurality of carriers configured as potential synchronization carrier for carrier aggregation (CA) by a BS, a carrier in which a sidelink synchronization signal is monitored by the UE, a carrier in which a physical sidelink broadcast channel (PSBCH) is monitored by the UE, and a carrier in which the UE performs the CA.

The selection of a synchronization carrier and a synchronization reference may include selecting the synchronization carrier based on indexes of a plurality of carriers. The selection of the synchronization carrier may include selecting a carrier having a lowest index as the synchronization carrier.

The selection of a synchronization carrier and a synchronization reference may include selecting the synchronization carrier based on physical-layer signaling or higher-layer signaling from a BS.

The selection of a synchronization carrier and a synchronization reference may include selecting the synchronization carrier in consideration of a capability of the UE.

The selection of a synchronization carrier and a synchronization reference may include when the synchronization reference is the BS, selecting a first carrier as the synchronization carrier, and when the synchronization reference is the GNSS, selecting a second carrier as the synchronization carrier.

The synchronization reference may be for CA in UE-to-UE communication.

In another aspect of the present disclosure, a UE for transmitting a sidelink synchronization signal in a wireless communication system includes a transceiver and a processor. The processor is configured to control the transceiver, select a synchronization carrier and a synchronization reference, and transmit a sidelink synchronization signal based on the synchronization carrier. When the synchronization reference is a BS or a GNSS, the UE selects the synchronization carrier between a carrier for PSCCH transmission and a carrier for PSSCH transmission.

The UE may communicate with at least one of a mobile terminal, a network, or an autonomous driving vehicle other than the UE.

The UE may execute at least one advanced driver assistance system (ADAS) function based on a signal for controlling movement of the UE.

The UE may receive a user input and switches a driving mode of the UE from an autonomous driving mode to a manual driving mode or from the manual driving mode to the autonomous driving mode according to the user input.

The UE may autonomously drive based on external object information, and the external object information may include at least one of information about the presence or absence of an object, information about a position of the object, information about a distance between the UE and the object, or information about a relative speed between the UE and the object.

### Advantageous Effects

According to the present disclosure, a method of, when a synchronization reference is a base station (BS) or a global navigation satellite system (GNSS), specifically configuring a carrier used to transmit a sidelink channel/signal may be provided.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the present disclosure and are incorporated in and constitute a part of this application, illustrate embodiments of the present disclosure and together with the description serve to explain the principle of the disclosure.

FIG. 1 illustrates a frame structure in new radio (NR).

FIG. 2 illustrates a resource grid in NR.

FIG. 3 illustrates sidelink synchronization.

FIG. 4 illustrates a time resource unit for transmitting a sidelink synchronization signal.

FIG. 5 illustrates a sidelink resource pool.

FIG. 6 illustrates scheduling schemes based on sidelink transmission modes.

FIG. 7 illustrates selection of sidelink transmission resources.

FIG. 8 illustrates transmission of a physical sidelink control channel (PSCCH).

FIG. 9 illustrates PSCCH transmission in sidelink vehicle-to-everything (V2X) communication.

FIG. 10 is a flowchart illustrating an embodiment of the present disclosure.

FIG. 11 is a flowchart illustrating an embodiment of the present disclosure.

FIG. 12 is a block diagram illustrating devices according to the present disclosure.

### BEST MODE

In this document, downlink (DL) communication refers to communication from a base station (BS) to a user equipment (UE), and uplink (UL) communication refers to communication from the UE to the BS. In DL, a transmitter may be a part of the BS and a receiver may be a part of the UE. In UL, a transmitter may be a part of the UE and a receiver may be a part of the BS. Herein, the BS may be referred to as a first communication device, and the UE may be referred to as a second communication device. The term ‘BS’ may be replaced with ‘fixed station’, ‘Node B’, ‘evolved Node B (eNB)’, ‘next-generation node B (gNB)’, ‘base transceiver system (BTS)’, ‘access point (AP)’, ‘network node’, ‘fifth-generation (5G) network node’, ‘artificial intelligence (AI) system’, ‘road side unit (RSU)’, ‘robot’, etc. The term ‘UE’ may be replaced with ‘terminal’, ‘mobile station (MS)’, ‘user terminal (UT)’, ‘mobile subscriber station (MSS)’, ‘subscriber station (SS)’, ‘advanced mobile station (AMS)’, ‘wireless terminal (WT)’, ‘machine type communication (MTC) device’, ‘machine-to-machine (M2M) device’, ‘device-to-device (D2D) device’, ‘vehicle’, ‘robot’, ‘AI module’, etc.

The technology described herein is applicable to various wireless access systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented as radio technology such as universal terrestrial radio access (UTRA) or CDMA2000. The TDMA may be implemented as radio technology such as global system for mobile communications (GSM), general packet radio service (GPRS), or enhanced data rates for GSM evolution (EDGE). The OFDMA may be implemented as radio technology such as the Institute of Electrical and Electronics Engineers (IEEE) 802.11 (Wi-Fi), IEEE 802.16 (WiMAX), IEEE 802-20, evolved UTRA (E-UTRA), etc. The UTRA is a part of a universal mobile telecommunication system (UMTS). 3rd generation partnership project (3GPP) long term evolution (LTE) is a part of evolved UMTS (E-UMTS) using E-UTRA. LTE-advance (LTE-A) or LTE-A pro is an evolved version of 3GPP LTE. 3GPP new radio or new radio access technology (3GPP NR) is an evolved version of 3GPP LTE, LTE-A, or LTE-A pro.

Although the present disclosure is described based on 3GPP communication systems (e.g., LTE-A, NR, etc.) for clarity of description, the spirit of the present disclosure is not limited thereto. LTE refers to technologies beyond 3GPP technical specification (TS) 36.xxx Release 8. In particular, LTE technologies beyond 3GPP TS 36.xxx Release 10 are referred to as LTE-A, and LTE technologies beyond 3GPP TS 36.xxx Release 13 are referred to as LTE-A pro. 3GPP NR refers to technologies beyond 3GPP TS 38.xxx Release 15. LTE/NR may be called ‘3GPP system’. Herein, “xxx” refers to a standard specification number.

In the present disclosure, a node refers to a fixed point capable of transmitting/receiving a radio signal for communication with a UE. Various types of BSs may be used as the node regardless of the names thereof. For example, the node may include a BS, a node B (NB), an eNB, a pico-cell eNB (PeNB), a home eNB (HeNB), a relay, a repeater, etc. A device other than the BS may be the node. For example, a radio remote head (RRH) or a radio remote unit (RRU) may be the node. The RRH or RRU generally has a lower power level than that of the BS. At least one antenna is installed for each node. The antenna may refer to a physical antenna or mean an antenna port, a virtual antenna, or an antenna group. The node may also be referred to as a point.

In the present disclosure, a cell refers to a prescribed geographical area in which one or more nodes provide communication services or a radio resource. When a cell refers to a geographical area, the cell may be understood as the coverage of a node where the node is capable of providing services using carriers. When a cell refers to a radio resource, the cell may be related to a bandwidth (BW), i.e., a frequency range configured for carriers. Since DL coverage, a range within which the node is capable of transmitting a valid signal, and UL coverage, a range within which the node is capable of receiving a valid signal from the UE, depend on carriers carrying the corresponding signals, the coverage of the node may be related to the coverage of the cell, i.e., radio resource used by the node. Accordingly, the term “cell” may be used to indicate the service coverage of a node, a radio resource, or a range to which a signal transmitted on a radio resource can reach with valid strength.

In the present disclosure, communication with a specific cell may mean communication with a BS or node that provides communication services to the specific cell. In addition, a DL/UL signal in the specific cell refers to a DL/UL signal from/to the BS or node that provides communication services to the specific cell. In particular, a cell providing DL/UL communication services to a UE may be called a serving cell. The channel state/quality of the specific cell may refer to the channel state/quality of a communication link formed between the BS or node, which provides communication services to the specific cell, and the UE.

When a cell is related to a radio resource, the cell may be defined as a combination of DL and UL resources, i.e., a combination of DL and UL component carriers (CCs). The cell may be configured to include only DL resources or a combination of DL and UL resources. When carrier aggregation is supported, a linkage between the carrier frequency of a DL resource (or DL CC) and the carrier frequency of a UL resource (or UL CC) may be indicated by system information transmitted on a corresponding cell. The carrier frequency may be equal to or different from the center frequency of each cell or CC. A cell operating on a primary frequency may be referred to as a primary cell (PCell) or PCC, and a cell operating on a secondary frequency may be referred to as a secondary cell (SCell) or SCC. The SCell may be configured after the UE and BS establish a radio resource control (RRC) connection therebetween by performing an RRC connection establishment procedure, that is, after the UE enters the RRC_CONNECTED state. The RRC connection may mean a path that enables the RRC of the UE and the RRC of the BS to exchange an RRC message. The SCell may be configured to provide additional radio resources to the UE. The SCell and the PCell may form a set of serving cells for the UE depending on the capabilities of the UE. When the UE is not configured with carrier aggregation or does not support the carrier aggregation although the UE is in the RRC_CONNECTED state, only one serving cell configured with the PCell exists.

A cell supports a unique radio access technology (RAT). For example, transmission/reception in an LTE cell is performed based on the LTE RAT, and transmission/reception in a 5G cell is performed based on the 5G RAT.

The carrier aggregation is a technology for combining a plurality of carriers each having a system BW smaller than a target BW to support broadband. The carrier aggregation is different from OFDMA in that in the former, DL or UL communication is performed on a plurality of carrier frequencies each forming a system BW (or channel BW) and in the latter, DL or UL communication is performed by dividing a base frequency band into a plurality of orthogonal subcarriers and loading the subcarriers in one carrier frequency. For example, in OFDMA or orthogonal frequency division multiplexing (OFDM), one frequency band with a predetermined system BW is divided into a plurality of subcarriers with a predetermined subcarrier spacing, and information/data is mapped to the plurality of subcarriers. Frequency up-conversion is applied to the frequency band to which the information/data is mapped, and the information/data is transmitted on the carrier frequency in the frequency band. In wireless carrier aggregation, multiple frequency bands, each of which has its own system BW and carrier frequency, may be simultaneously used for communication, and each frequency band used in the carrier aggregation may be divided into a plurality of subcarriers with a predetermined subcarrier spacing.

3GPP communication specifications define DL physical channels corresponding to resource elements carrying information originating from higher (upper) layers of physical layers (e.g., a medium access control (MAC) layer, a radio link control (RLC) layer, a protocol data convergence protocol (PDCP) layer, an RRC layer, a service data adaptation protocol (SDAP) layer, a non-access stratum (NAS) layer, etc.) and DL physical signals corresponding to resource elements which are used by physical layers but do not carry information originating from higher layers. For example, a physical downlink shared channel (PDSCH), a physical broadcast channel (PBCH), a physical multicast channel (PMCH), a physical control format indicator channel (PCFICH), and a physical downlink control channel (PDCCH) are defined as the DL physical channels, and a reference signal and a synchronization signal are defined as the DL physical signals. A reference signal (RS), which is called a pilot signal, refers to a predefined signal with a specific waveform known to both the BS and UE. For example, a cell-specific RS (CRS), a UE-specific RS (UE-RS), a positioning RS (PRS), a channel state information RS (CSI-RS), and a demodulation reference signal (DMRS) may be defined as DL RSs. In addition, the 3GPP communication specifications define UL physical channels corresponding to resource elements carrying information originating from higher layers and UL physical signals corresponding to resource elements which are used by physical layers but do not carry information originating from higher layers. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signals.

In the present disclosure, the PDCCH and the PDSCH may refer to a set of time-frequency resources or resource elements carrying downlink control information (DCI) of the physical layer and a set of time-frequency resources or resource elements carrying DL data thereof, respectively. The PUCCH, the PUSCH, and the PRACH may refer to a set of time-frequency resources or resource elements carrying uplink control information (UCI) of the physical layer, a set of time-frequency resources or resource elements carrying UL data thereof, and a set of time-frequency resources or resource elements carrying random access signals thereof, respectively. When it is said that a UE transmits a UL physical channel (e.g., PUCCH, PUSCH, PRACH, etc.), it may mean that the UE transmits DCI, UL data, or a random access signal on or over the corresponding UL physical channel. When it is said that the BS receives a UL physical channel, it may mean that the BS receives DCI, UL data, a random access signal on or over the corresponding UL physical channel. When it is said that the BS transmits a DL physical channel (e.g., PDCCH, PDSCH, etc.), it may mean that the BS transmits DCI or UL data on or over the corresponding DL physical channel. When it is said that the UE receives a DL physical channel, it may mean that the UE receives DCI or UL data on or over the corresponding DL physical channel.

In the present disclosure, a transport block may mean the payload for the physical layer. For example, data provided from the higher layer or MAC layer to the physical layer may be referred to as the transport block.

In the present disclosure, hybrid automatic repeat request (HARQ) may mean a method used for error control. A HARQ acknowledgement (HARQ-ACK) transmitted in DL is used to control an error for UL data, and a HARQ-ACK transmitted in UL is used to control an error for DL data. A transmitter that performs the HARQ operation waits for an ACK signal after transmitting data (e.g. transport blocks or codewords). A receiver that performs the HARQ operation transmits an ACK signal only when the receiver correctly receives data. If there is an error in the received data, the receiver transmits a negative ACK (NACK) signal. Upon receiving the ACK signal, the transmitter may transmit (new) data but, upon receiving the NACK signal, the transmitter may retransmit the data. Meanwhile, there may be a time delay until the BS receives ACK/NACK from the UE and retransmits data after transmitting scheduling information and data according to the scheduling information. The time delay occurs due to a channel propagation delay or a time required for data decoding/encoding. Accordingly, if new data is transmitted after completion of the current HARQ process, there may be a gap in data transmission due to the time delay. To avoid such a gap in data transmission during the time delay, a plurality of independent HARQ processes are used. For example, when there are 7 transmission occasions between initial transmission and retransmission, a communication device may perform data transmission with no gap by managing 7 independent HARQ processes. When the communication device uses a plurality of parallel HARQ processes, the communication device may successively perform UL/DL transmission while waiting for HARQ feedback for previous UL/DL transmission.

In the present disclosure, CSI collectively refers to information indicating the quality of a radio channel (also called a link) created between a UE and an antenna port. The CSI includes at least one of a channel quality indicator (CQI), a precoding matrix indicator (PMI), a CSI-RS resource indicator (CRI), an SSB resource indicator (SSBRI), a layer indicator (LI), a rank indicator (RI), or a reference signal received power (RSRP).

In the present disclosure, frequency division multiplexing (FDM) may mean that signals/channels/users are transmitted/received on different frequency resources, and time division multiplexing (TDM) may mean that signals/channels/users are transmitted/received on different time resources.

In the present disclosure, frequency division duplex (FDD) refers to a communication scheme in which UL communication is performed on a UL carrier and DL communication is performed on a DL carrier linked to the UL carrier, and time division duplex (TDD) refers to a communication scheme in which UL and DL communication are performed by splitting time.

The details of the background, terminology, abbreviations, etc. used herein may be found in documents published before the present disclosure. For example, 3GPP TS 24 series, 3GPP TS 34 series, and 3GPP TS 38 series may be referenced (http://www.3gpp.org/specifications/specification-numbering).

Frame Structure

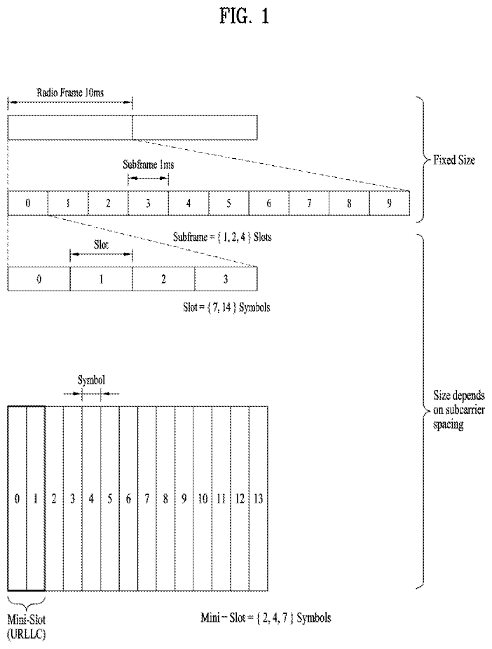

FIG. 1 is a diagram illustrating a frame structure in NR.

The NR system may support multiple numerologies. The numerology is defined by a subcarrier spacing and cyclic prefix (CP) overhead. A plurality of subcarrier spacings may be derived by scaling a basic subcarrier spacing by an integer N (or μ). The numerology may be selected independently of the frequency band of a cell although it is assumed that a small subcarrier spacing is not used at a high carrier frequency. In addition, the NR system may support various frame structures based on the multiple numerologies.

Hereinafter, an OFDM numerology and a frame structure, which may be considered in the NR system, will be described. Table 1 shows multiple OFDM numerologies supported in the NR system. The value of μ for a bandwidth part and a CP may be obtained by RRC parameters provided by the BS.

TABLE 1

| μ | Δf = 2^{μ}*15 [kHz] | Cyclic prefix(CP) |
|---|---|---|
| 0 | 15 | Normal |
| 1 | 30 | Normal |
| 2 | 60 | Normal, Extended |
| 3 | 120 | Normal |
| 4 | 240 | Normal |

The NR system supports multiple numerologies (e.g., subcarrier spacings) to support various 5G services. For example, the NR system supports a wide area in conventional cellular bands in a subcarrier spacing of 15 kHz and supports a dense urban environment, low latency, and wide carrier BW in a subcarrier spacing of 30/60 kHz. In a subcarrier spacing of 60 kHz or above, the NR system supports a BW higher than 24.25 GHz to overcome phase noise.

Resource Grid

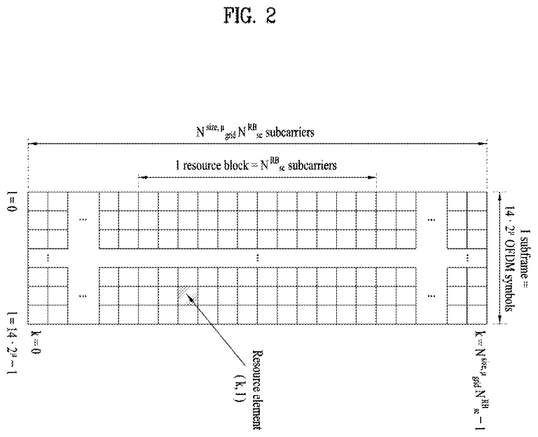

FIG. 2 illustrates a resource grid in the NR.

Referring to FIG. 2, a resource grid consisting of Nsize,μgrid*NRBsc subcarriers and 14*2μ, OFDM symbols may be defined for each subcarrier spacing configuration and carrier, where Nsize,μgrid is indicated by RRC signaling from the BS. Nsize,μgrid may vary not only depending on the subcarrier spacing configuration μ. but also between UL and DL. One resource grid exists for the subcarrier spacing configuration an antenna port p, and a transmission direction (i.e., UL or DL). Each element in the resource gird for the subcarrier spacing configuration μ. and the antenna port p may be referred to as a resource element and identified uniquely by an index pair of (k, l), where k denotes an index in the frequency domain and l denotes the relative location of a symbol in the frequency domain with respect to a reference point. The resource element (k, l) for the subcarrier spacing configuration μ. and the antenna port p may be a physical resource and a complex value, a(p,μ)k,l. A resource block (RB) is defined as NRBsc consecutive subcarriers in the frequency domain (where NRBsc=12).

Considering that the UE is incapable of supporting a wide BW supported in the NR system, the UE may be configured to operate in a part of the frequency BW of a cell (hereinafter referred to as a bandwidth part (BWP)).

Bandwidth Part (BWP)

The NR system may support up to 400 MHz for each carrier. If the UE always keeps a radio frequency (RF) module on for all carriers while operating on such a wideband carrier, the battery consumption of the UE may increase. Considering multiple use cases (e.g., eMBB, URLLC, mMTC, V2X, etc.) operating in one wideband carrier, a different numerology (e.g., subcarrier spacing) may be supported for each frequency band of the carrier. Further, considering that each UE may have a different capability regarding the maximum BW, the BS may instruct the UE to operate only in a partial BW rather than the whole BW of the wideband carrier. The partial bandwidth is referred to as the BWP. The BWP is a subset of contiguous common RBs defined for numerology pi in BWP i of the carrier in the frequency domain, and one numerology (e.g., subcarrier spacing, CP length, and/or slot/mini-slot duration) may be configured for the BWP.

The BS may configure one or more BWPs in one carrier configured for the UE. Alternatively, if UEs are concentrated in a specific BWP, the BS may move some UEs to another BWP for load balancing. For frequency-domain inter-cell interference cancellation between neighbor cells, the BS may configure BWPs on both sides of a cell except for some central spectra in the whole BW in the same slot. That is, the BS may configure at least one DL/UL BWP for the UE associated with the wideband carrier, activate at least one of DL/UL BWP(s) configured at a specific time (by L1 signaling which is a physical-layer control signal, a MAC control element (CE) which is a MAC-layer control signal, or RRC signaling), instruct the UE to switch to another configured DL/UL BWP (by L1 signaling, a MAC CE, or RRC signaling), or set a timer value and switch the UE to a predetermined DL/UL BWP upon expiration of the timer value. In particular, an activated DL/UL BWP is referred to as an active DL/UL BWP. While performing initial access or before setting up an RRC connection, the UE may not receive a DL/UL BWP configuration. A DL/UL BWP that the UE assumes in this situation is referred to as an initial active DL/UL BWP.

Synchronization Acquisition of Sidelink UE

In time division multiple access (TDMA) and frequency division multiple access (FDMA) systems, accurate time and frequency synchronization is essential. If time and frequency synchronization is not accurate, inter-symbol interference (ISI) and inter-carrier interference (ICI) may occur so that system performance may be degraded. This may occur in V2X. For time/frequency synchronization in V2X, a sidelink synchronization signal (SLSS) may be used in the physical layer, and master information block-sidelink-V2X (MIB-SL-V2X) may be used in the RLC layer.

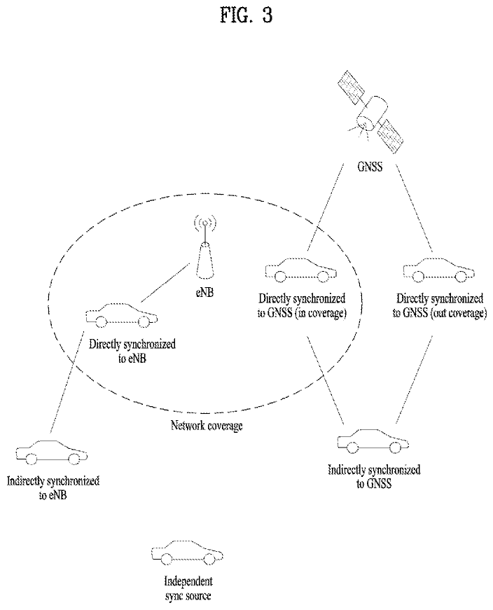

FIG. 3 illustrates a synchronization source and a synchronization reference in V2X.

Referring to FIG. 3, in V2X, a UE may be directly synchronized to global navigation satellite systems (GNSS) or indirectly synchronized to the GNSS through another UE (in or out of the network coverage) that is directly synchronized to the GNSS. When the GNSS is set to the synchronization source, the UE may calculate a direct frame number (DFN) and a subframe number based on coordinated universal time (UTC) and a (pre)configured DFN offset.

Alternatively, the UE may be directly synchronized to the BS or synchronized to another UE that is time/frequency synchronized to the BS. For example, if the UE is in the coverage of the network, the UE may receive synchronization information provided by the BS and be directly synchronized to the BS. Thereafter, the UE may provide the synchronization information to another adjacent UE. If the timing of the BS is set to the synchronization reference, the UE may follow a cell associated with a corresponding frequency (if the UE is in the cell coverage at the corresponding frequency) or follow a PCell or serving cell (if the UE is out of the cell coverage at the corresponding frequency) for synchronization and DL measurement.

The serving cell (BS) may provide a synchronization configuration for carriers used in V2X sidelink communication. In this case, the UE may follow the synchronization configuration received from the BS. If the UE detects no cell from the carriers used in the V2X sidelink communication and receives no synchronization configuration from the serving cell, the UE may follow a predetermined synchronization configuration.

Alternatively, the UE may be synchronized to another UE that fails to directly or indirectly obtain the synchronization information from the BS or GNSS. The synchronization source and preference may be preconfigured for the UE or configured in a control message from the BS.

Hereinbelow, the SLSS and synchronization information will be described.

The SLSS may be a sidelink-specific sequence and include a primary sidelink synchronization signal (PSSS) and a secondary sidelink synchronization signal (SSSS).

Each SLSS may have a physical layer sidelink synchronization identity (ID), and the value may be, for example, any of 0 to 335. The synchronization source may be identified depending on which of the above values is used. For example, 0, 168, and 169 may indicate the GNSS, 1 to 167 may indicate the BS, and 170 to 335 may indicate out-of-coverage. Alternatively, among the values of the physical layer sidelink synchronization ID, 0 to 167 may be used by the network, and 168 to 335 may be used for the out-of-coverage state.

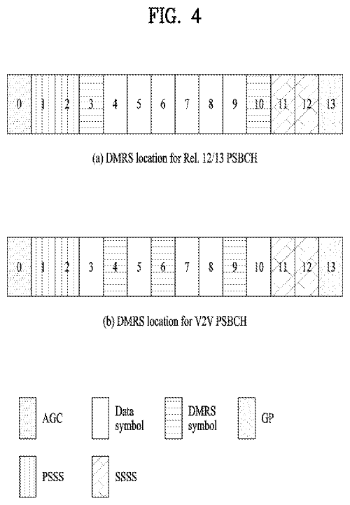

FIG. 4 illustrates a time resource unit for SLSS transmission. The time resource unit may be a subframe in LTE/LTE-A and a slot in 5G. The details may be found in 3GPP TS 36 series or 3GPP TS 28 series. A physical sidelink broadcast channel (PSBCH) may refer to a channel for carrying (broadcasting) basic (system) information that the UE needs to know before sidelink signal transmission and reception (e.g., SLSS-related information, a duplex mode (DM), a TDD UL/DL configuration, information about a resource pool, the type of an SLSS-related application, a subframe offset, broadcast information, etc.). The PSBCH and SLSS may be transmitted in the same time resource unit, or the PSBCH may be transmitted in a time resource unit after that in which the SLSS is transmitted. A DMRS may be used to demodulate the PSBCH.

Sidelink Transmission Mode

For sidelink communication, transmission modes 1, 2, 3 and 4 are used.

In transmission mode 1/3, the BS performs resource scheduling for UE 1 over a PDCCH (more specifically, DCI) and UE 1 performs D2D/V2X communication with UE 2 according to the corresponding resource scheduling. After transmitting sidelink control information (SCI) to UE 2 over a physical sidelink control channel (PSCCH), UE 1 may transmit data based on the SCI over a physical sidelink shared channel (PSSCH). Transmission modes 1 and 3 may be applied to D2D and V2X, respectively.

Transmission mode 2/4 may be a mode in which the UE performs autonomous scheduling (self-scheduling). Specifically, transmission mode 2 is applied to D2D. The UE may perform D2D operation by autonomously selecting a resource from a configured resource pool. Transmission mode 4 is applied to V2X. The UE may perform V2X operation by autonomously selecting a resource from a selection window through a sensing process. After transmitting the SCI to UE 2 over the PSCCH, UE 1 may transmit data based on the SCI over the PSSCH. Hereinafter, the term ‘transmission mode’ may be simply referred to as ‘mode’.

Control information transmitted by a BS to a UE over a PDCCH may be referred to as DCI, whereas control information transmitted by a UE to another UE over a PSCCH may be referred to as SCI. The SCI may carry sidelink scheduling information. The SCI may have several formats, for example, SCI format 0 and SCI format 1.

SCI format 0 may be used for scheduling the PSSCH. SCI format 0 may include a frequency hopping flag (1 bit), a resource block allocation and hopping resource allocation field (the number of bits may vary depending on the number of sidelink RBs), a time resource pattern (7 bits), a modulation and coding scheme (MCS) (5 bits), a time advance indication (11 bits), a group destination ID (8 bits), etc.

SCI format 1 may be used for scheduling the PSSCH. SCI format 1 may include a priority (3 bits), a resource reservation (4 bits), the location of frequency resources for initial transmission and retransmission (the number of bits may vary depending on the number of sidelink subchannels), a time gap between initial transmission and retransmission (4 bits), an MCS (5 bits), a retransmission index (1 bit), a reserved information bit, etc. Hereinbelow, the term ‘reserved information bit’ may be simply referred to as ‘reserved bit’. The reserved bit may be added until the bit size of SCI format 1 becomes 32 bits.

SCI format 0 may be used for transmission modes 1 and 2, and SCI format 1 may be used for transmission modes 3 and 4.

Sidelink Resource Pool

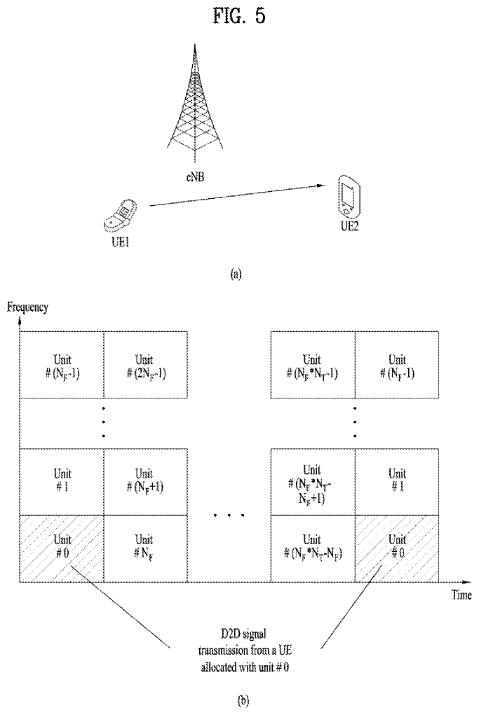

FIG. 5 shows an example of a first UE (UE1), a second UE (UE2) and a resource pool used by UE1 and UE2 performing sidelink communication.

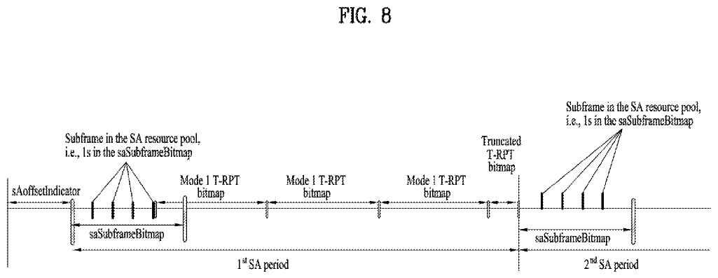

In FIG. 5(a), a UE corresponds to a terminal or such a network device as a BS transmitting and receiving a signal according to a sidelink communication scheme. A UE selects a resource unit corresponding to a specific resource from a resource pool corresponding to a set of resources and the UE transmits a sidelink signal using the selected resource unit. UE2 corresponding to a receiving UE receives a configuration of a resource pool in which UE1 is able to transmit a signal and detects a signal of UE1 in the resource pool. In this case, if UE1 is located in the coverage of a BS, the BS may inform UE1 of the resource pool. If UE1 is located out of the coverage of the BS, the resource pool may be informed by a different UE or may be determined by a predetermined resource. In general, a resource pool includes a plurality of resource units. A UE selects one or more resource units from among a plurality of the resource units and may be able to use the selected resource unit(s) for sidelink signal transmission. FIG. 5(b) shows an example of configuring a resource unit. Referring to FIG. 8(b), the entire frequency resources are divided into the NF number of resource units and the entire time resources are divided into the NT number of resource units. In particular, it is able to define NF*NT number of resource units in total. In particular, a resource pool may be repeated with a period of NT subframes. Specifically, as shown in FIG. 8, one resource unit may periodically and repeatedly appear. Or, an index of a physical resource unit to which a logical resource unit is mapped may change with a predetermined pattern according to time to obtain a diversity gain in time domain and/or frequency domain. In this resource unit structure, a resource pool may correspond to a set of resource units capable of being used by a UE intending to transmit a sidelink signal.

A resource pool may be classified into various types. First of all, the resource pool may be classified according to contents of a sidelink signal transmitted via each resource pool. For example, the contents of the sidelink signal may be classified into various signals and a separate resource pool may be configured according to each of the contents. The contents of the sidelink signal may include a scheduling assignment (SA or physical sidelink control channel (PSCCH)), a sidelink data channel, and a discovery channel. The SA may correspond to a signal including information on a resource position of a sidelink data channel, information on a modulation and coding scheme (MCS) necessary for modulating and demodulating a data channel, information on a MIMO transmission scheme, information on a timing advance (TA), and the like. The SA signal may be transmitted on an identical resource unit in a manner of being multiplexed with sidelink data. In this case, an SA resource pool may correspond to a pool of resources that an SA and sidelink data are transmitted in a manner of being multiplexed. The SA signal may also be referred to as a sidelink control channel or a physical sidelink control channel (PSCCH). The sidelink data channel (or, physical sidelink shared channel (PSSCH)) corresponds to a resource pool used by a transmitting UE to transmit user data. If an SA and a sidelink data are transmitted in a manner of being multiplexed in an identical resource unit, sidelink data channel except SA information may be transmitted only in a resource pool for the sidelink data channel. In other word, REs, which are used to transmit SA information in a specific resource unit of an SA resource pool, may also be used for transmitting sidelink data in a sidelink data channel resource pool. The discovery channel may correspond to a resource pool for a message that enables a neighboring UE to discover transmitting UE transmitting information such as ID of the UE, and the like.

Despite the same contents, sidelink signals may use different resource pools according to the transmission and reception properties of the sidelink signals. For example, despite the same sidelink data channels or the same discovery messages, they may be distinguished by different resource pools according to transmission timing determination schemes for the sidelink signals (e.g., whether a sidelink signal is transmitted at the reception time of a synchronization reference signal or at a time resulting from applying a predetermined TA to the reception time of the synchronization reference signal), resource allocation schemes for the sidelink signals (e.g., whether a BS configures the transmission resources of an individual signal for an individual transmitting UE or the individual transmitting UE autonomously selects the transmission resources of an individual signal in a pool), the signal formats of the sidelink signals (e.g., the number of symbols occupied by each sidelink signal in one subframe or the number of subframes used for transmission of a sidelink signal), signal strengths from the BS, the transmission power of a sidelink UE, and so on. In sidelink communication, a mode in which a BS directly indicates transmission resources to a sidelink transmitting UE is referred to as sidelink transmission mode 1, and a mode in which a transmission resource area is preconfigured or the BS configures a transmission resource area and the UE directly selects transmission resources is referred to as sidelink transmission mode 2. In sidelink discovery, a mode in which a BS directly indicates resources is referred to as Type 2, and a mode in which a UE selects transmission resources directly from a preconfigured resource area or a resource area indicated by the BS is referred to as Type 1.

In V2X, sidelink transmission mode 3 based on centralized scheduling and sidelink transmission mode 4 based on distributed scheduling are available.

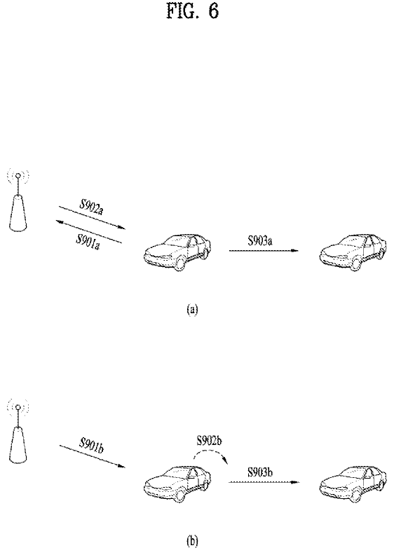

FIG. 6 illustrates scheduling schemes based on these two transmission modes. Referring to FIG. 6, in transmission mode 3 based on centralized scheduling of FIG. 6(a), a vehicle requests sidelink resources to a BS (S901a), and the BS allocates the resources (S902a). Then, the vehicle transmits a signal on the resources to another vehicle (S903a). In the centralized transmission, resources on another carrier may also be scheduled. In transmission mode 4 based on distributed scheduling of FIG. 6(b), a vehicle selects transmission resources (S902b) by sensing a resource pool, which is preconfigured by a BS (S901b). Then, the vehicle may transmit a signal on the selected resources to another vehicle (S903b).

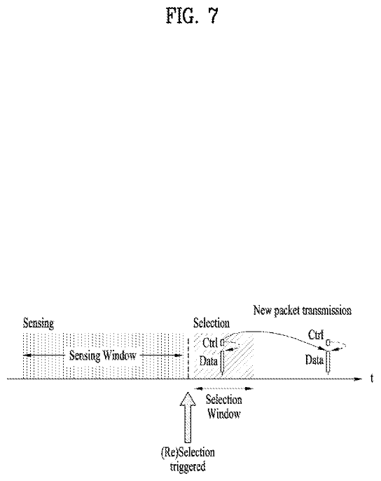

When the transmission resources are selected, transmission resources for a next packet are also reserved as illustrated in FIG. 7. In V2X, transmission is performed twice for each MAC PDU. When resources for initial transmission are selected, resources for retransmission are also reserved with a predetermined time gap from the resources for the initial transmission. The UE may identify transmission resources reserved or used by other UEs through sensing in a sensing window, exclude the transmission resources from a selection window, and randomly select resources with less interference from among the remaining resources.

For example, the UE may decode a PSCCH including information about the cycle of reserved resources within the sensing window and measure PSSCH RSRP on periodic resources determined based on the PSCCH. The UE may exclude resources with PSCCH RSRP more than a threshold from the selection window. Thereafter, the UE may randomly select sidelink resources from the remaining resources in the selection window.

Alternatively, the UE may measure received signal strength indication (RSSI) for the periodic resources in the sensing window and identify resources with less interference, for example, the bottom 20 percent. After selecting resources included in the selection window from among the periodic resources, the UE may randomly select sidelink resources from among the resources included in the selection window. For example, when PSCCH decoding fails, the above method may be applied.

The details thereof may be found in clause 14 of 3GPP TS 3GPP TS 36.213 V14.6.0, which are incorporated herein by reference.

Transmission and Reception of PSCCH

In sidelink transmission mode 1, a UE may transmit a PSCCH (sidelink control signal, SCI, etc.) on a resource configured by a BS. In sidelink transmission mode 2, the BS may configure resources used for sidelink transmission for the UE, and the UE may transmit the PSCCH by selecting a time-frequency resource from among the configured resources.

FIG. 8 shows a PSCCH period defined for sidelink transmission mode 1 or 2.

Referring to FIG. 8, a first PSCCH (or SA) period may start in a time resource unit apart by a predetermined offset from a specific system frame, where the predetermined offset is indicated by higher layer signaling. Each PSCCH period may include a PSCCH resource pool and a time resource unit pool for sidelink data transmission. The PSCCH resource pool may include the first time resource unit in the PSCCH period to the last time resource unit among time resource units indicated as carrying a PSCCH by a time resource unit bitmap. In mode 1, since a time-resource pattern for transmission (T-RPT) or a time-resource pattern (TRP) is applied, the resource pool for sidelink data transmission may include time resource units used for actual transmission. As shown in the drawing, when the number of time resource units included in the PSCCH period except for the PSCCH resource pool is more than the number of T-RPT bits, the T-RPT may be applied repeatedly, and the last applied T-RPT may be truncated as many as the number of remaining time resource units. A transmitting UE performs transmission at a T-RPT position of 1 in a T-RPT bitmap, and transmission is performed four times in one MAC PDU.

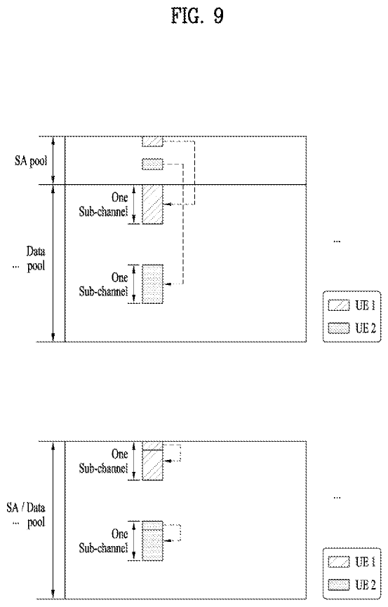

In V2X, that is, sidelink transmission mode 3 or 4, a PSCCH and data (PSSCH) are frequency division multiplexed (FDM) and transmitted, unlike sidelink communication. Since latency reduction is important in V2X in consideration of the nature of vehicle communication, the PSCCH and data are FDM and transmitted on the same time resources but different frequency resources. FIG. 9 illustrates examples of this transmission scheme. The PSCCH and data may not be contiguous to each other as illustrated in FIG. 9(a) or may be contiguous to each other as illustrated in FIG. 9(b). A subchannel is used as the basic unit for the transmission. The subchannel is a resource unit including one or more RBs in the frequency domain within a predetermined time resource (e.g., time resource unit). The number of RBs included in the subchannel, i.e., the size of the subchannel and the starting position of the subchannel in the frequency domain are indicated by higher layer signaling.

For V2V communication, a periodic type of cooperative awareness message (CAM) and an event-triggered type of decentralized environmental notification message (DENM) may be used. The CAM may include dynamic state information of a vehicle such as direction and speed, vehicle static data such as dimensions, and basic vehicle information such as ambient illumination states, path details, etc. The CAM may be 50 to 300 bytes long. In addition, the CAM is broadcast, and its latency should be less than 100 ms. The DENM may be generated upon occurrence of an unexpected incident such as a breakdown, an accident, etc. The DENM may be shorter than 3000 bytes, and it may be received by all vehicles within the transmission range. The DENM may have priority over the CAM. When it is said that messages are prioritized, it may mean that from the perspective of a UE, if there are a plurality of messages to be transmitted at the same time, a message with the highest priority is preferentially transmitted, or among the plurality of messages, the message with highest priority is transmitted earlier in time than other messages. From the perspective of multiple UEs, a high-priority message may be regarded to be less vulnerable to interference than a low-priority message, thereby reducing the probability of reception error. If security overhead is included in the CAM, the CAM may have a large message size compared to when there is no security overhead.

Sidelink Congestion Control

A sidelink radio communication environment may easily become congested according to increases in the density of vehicles, the amount of information transfer, etc. Various methods are applicable for congestion reduction. For example, distributed congestion control may be applied.

In the distributed congestion control, a UE understands the congestion level of a network and performs transmission control. In this case, the congestion control needs to be performed in consideration of the priorities of traffic (e.g., packets).

Specifically, each UE may measure a channel busy ratio (CBR) and then determine the maximum value (CRIimitk) of a channel occupancy ratio (CRk) that can be occupied by each traffic priority (e.g., k) according to the CBR. For example, the UE may calculate the maximum value (CRIimitk) of the channel occupancy ratio for each traffic priority based on CBR measurement values and a predetermined table. If traffic has a higher priority, the maximum value of the channel occupancy ratio may increase.

The UE may perform the congestion control as follows. The UE may limit the sum of the channel occupancy ratios of traffic with a priority k such that the sum does not exceed a predetermined value, where k is less than i. According to this method, the channel occupancy ratios of traffic with low priorities are further restricted.

Besides, the UE may use methods such as control of the magnitude of transmission power, packet drop, determination of retransmission or non-retransmission, and control of the size of a transmission RB (MCS adjustment).

5G Use Cases

Three key requirement areas of 5G (e.g., NR) include (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data. rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple 5G use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

Selection of Synchronization Source and Synchronization Carrier

A synchronization reference may be selected in the following methods. The following description is merely exemplary, which should not be construed as limiting the methods of selecting a synchronization reference according to the present disclosure. Rather, these methods may be applied to the present disclosure in combination with the foregoing other methods of selecting a synchronization reference.

For example, when a synchronization carrier frequency has not been selected, the UE may operate as follows.

The UE may receive information indicating the type of a synchronization reference for sidelink (SL) communication (e.g., typeTxSync or SL-TypeTxSync) from the BS by RRC signaling. When the information indicating the type of a synchronization reference indicates a BS (e.g., eNB or gNB), the UE may use a cell (e.g., PCell, SCell, or serving cell) as a reference. In another example, i) when the information indicating the type of a synchronization reference has not been acquired (configured) or ii) when the information indicating the type of a synchronization reference that the UE has acquired from the BS by RRC signaling indicates the GNSS, the UE may select the GNSS as the synchronization reference source.

In another example, when a synchronization carrier frequency has been selected, the UE may operate as follows.

A synchronization reference source (e.g., BS, GNSS, or SyncRef UE) selected for the synchronization carrier frequency may be considered as a synchronization reference.

A synchronization carrier frequency may be selected in the following manner. The following description is merely exemplary, which should not be construed as limiting the method of selecting a synchronization carrier (or synchronization carrier frequency) according to the present disclosure. Rather, this method may be applied to the present disclosure in combination with the foregoing other methods of selecting a synchronization carrier (or anchor carrier).

The UE may select a synchronization carrier frequency differently i) when a selected synchronization carrier does not exist and ii) when the selected synchronization carrier exists but a network entity (e.g., BS, GNSS, or SyncRef UE) selected as a synchronization source does not satisfy a specific condition.

For example, when the selected synchronization carrier does not exist, the UE may operate as follows.

The UE may receive information indicating the type of a synchronization reference for SL communication (e.g., typeTxSync or SL-TypeTxSync) from the BS by RRC signaling. When the information indicating the type of a synchronization reference indicates the BS (e.g., eNB or gNB) or the GNSS, the UE may select, as a synchronization reference frequency, one of frequencies included in information (e.g., syncFreqList) representing a list of candidate carrier frequencies available for synchronization of SL communication, received from the BS.

In another example, when the selected synchronization carrier exists but a network entity (e.g., BS, GNSS, or SyncRef UE) selected as a synchronization source does not satisfy a specific condition, the UE may consider that a synchronization carrier frequency has not been selected.

The present disclosure proposes a method of transmitting a synchronization signal and a method of selecting a synchronization source (e.g., a synchronization carrier), when carrier aggregation (CA) is performed in UE-to-UE communication. Unless mentioned otherwise, the following proposed methods may also be extended to other types of wireless terminals and other scenarios. The terms anchor carrier, sync carrier, and so on are interchangeably used in the same meaning in the present disclosure. Further, the terms synchronization source, sync source, sync resource, frequency resource, and so on are interchangeably used in the same meaning. An anchor carrier may refer to a carrier related to detection of an SLSS. Further, intraband CA may mean that multiple DL CCs and/or multiple UL CCs are located adjacent to or close to each other in frequency or the carrier frequencies of DL CCs and/or UL CCs are in the same band.

When the UE performs CA or transmits or receives a signal in multiple frequency resources (e.g., CCs), it is necessary to align subframe boundaries between the CCs in terms of power efficiency. For subframe boundary alignment, once the UE selects a synchronization source in a specific CC, the UE may also keep using the synchronization source in another CC, so that subframe boundaries may be aligned between the CCs.

In this context, the following operations may be considered.

UE-specific synchronization anchor carrier selection: the UE may select a synchronization source having the highest of the priorities of synchronization sources monitored in respective CCs as its synchronization reference. For this purpose, the CCs need to be identical in synchronization source priorities. Thus, a specific CC group should be configured to have the same synchronization source priorities and/or the same priority between GNSS and eNB. i) The same synchronization source priorities and/or ii) the same priority between a network entity (e.g., GNSS) and a BS (e.g., eNB or gNB) or between at least two BSs should be set for a specific CC group. For this purpose, the network may signal a CC group having the same priorities to the UE by physical-layer signaling or higher-layer signaling (e.g., RRC signaling). For example, the BS may transmit to the UE i) information indicating which CC group has the same priorities and ii) information indicating priorities for each CC group by physical-layer signaling or higher-layer signaling. This method is intended to apply a highest-priority timing commonly to other CCs by selecting a highest-priority synchronization source, so that a high-priority synchronization signal is transmitted to neighbor UEs. When the UE is to (re)select a synchronization source, the UE may also monitor the sync sources of other CCs. Upon identification (discovery) of a highest-priority synchronization source, the UE may select the identified (discovered) synchronization source and align the subframe boundaries of all CCs with the synchronization source. The UE may set the same subframe boundary for all CCs based on synchronization resources related to the highest-priority synchronization source.

Prioritized and UE-specific synchronization anchor carrier selection: the UE may determine the subframe boundary of each CC based on a synchronization source monitored in a predetermined CC. When the UE fails to identify (discover) another synchronization signal in the predetermined CC, the UE may monitor a synchronization source in a lower-priority CC and determine the subframe boundary of each CC based on the synchronization source. For example, this method may be extended as a method of, when a UE fails in identifying (discovering) a synchronization source having a priority equal to or higher than a predetermined priority in a specific CC, selecting a synchronization source in a lower-layer CC. For this purpose, synchronization source selection priorities for each CC and a minimum priority level for a synchronization source to be monitored in each CC may be predetermined or signaled to the UE by physical-layer signaling or higher-layer signaling from the network (or the BS).

This method offers the technical effect of preventing unnecessary timing misalignment in other CCs, caused by following synchronization source selection of a specific CC in spite of failure in identifying (discovering) a high-priority synchronization in the specific CC. A flexible and adaptive wireless communication system may be provided in that when a high-priority synchronization source has not been identified (discovered) in a specific CC and a better (appropriate) synchronization source has been identified (discovered) in another CC, the network (e.g., BS) may select the synchronization source of the CC.

Alternatively, when the same source priority (synchronization source priority) is identified (discovered) in multiple CCs, a CC having a high RSRP (e.g., synchronization-RSRP (S-RSRP)) measurement may be selected. While the following description is given in the context of S-RSRP, for convenience, the present disclosure may also be applied to other types of RSRPs, not limited to S-RSRP. Alternatively, when the same sync source priority is identified (discovered) in multiple CCs, the priority of each CC may be predefined or indicated by the network. Alternatively, an S-RSRP offset (predetermined or indicated by the network) is set for each carrier, and the UE may apply offsets to the S-RSRP measurements of the multiple CCs and then select a CC finally. Alternatively, if the same synchronization resource priority (synchronization source priority) is identified (discovered) in different CCs, a final CC may be selected randomly or depending on UE implementation.

Extension of the above method may lead to the rule that even when synchronization sources have different priorities, not a synchronization source having the highest priority but a synchronization source in a frequency (e.g., carrier) with a certain or higher quality and an S-RSRP difference equal to or larger than a predetermined threshold from that of a lower-priority synchronization source is selected. Alternatively, the selection order of carriers, that is, the priorities of carriers may be predefined, or a minimum S-RSRP measurement condition may be predefined or indicated by the network, for each carrier/synchronization priority.

From the perspective of a Rel. 15 UE, a carrier with a Rel. 14 UE may be considered to be a synchronization anchor carrier. This carrier with a Rel. 14 UE is configured as a synchronization anchor carrier. In the absence of any Rel. 14 UE in the other carriers, the Rel. 15 UE needs to transmit and receive synchronization signals only on the anchor carrier. To this end, a method of configuring a carrier expected to have a Rel. 14 UE as a synchronization anchor carrier by a network is proposed.

When an anchor carrier is configured and carriers having the same timing as the anchor carrier are grouped into the same group, an equal direct frame number or D2D frame number (DFN) offset should be set for each group so that final subframe boundaries are aligned. Accordingly, it is proposed that the network sets the same DFN offset for each carrier group (signaled on a CC basis) or signals only one DFN offset for each carrier group.

The number of anchor carriers that the UE is capable of configuring may depend on the performance (e.g., UE capability) of the UE. For example, a UE equipped with a plurality of synchronization signal detectors may operate a plurality of anchor carriers, whereas a UE equipped with a single synchronization signal detector may operate a single anchor carrier. The number of anchor carriers or the UE capability may be expressed in other ways. For example, the number of anchor carriers or the UE capability may be expressed as the capability of independently tracking synchronization signals at different timings, the capability of transmitting or receiving SLSSs/PSBCHs simultaneously or independently in different CCs, or the capability of simultaneously searching for, transmitting, or receiving SLSSs/PSBCHs in different CCs. This anchor carrier capability or SLSS/PSBCH search capability may be given to the UE, apart from the capability of transmitting or receiving CCs simultaneously. This is because the number of data transmission or reception chains and the number of synchronization signal detectors or synchronization signal transmitters may be configured differently or independently.

When a maximum number of anchor carriers configured by the network is different from the UE capability, the network may pre-indicate the order of anchor carriers to be used. For example, when four anchor carriers are indicated but the UE is capable of tracking up to two asynchronous SLSSs/PSBCHs, the UE may configure anchor carriers in ascending order of carrier frequencies. Alternatively, this order may dependent on UE implementation. Alternatively, a carrier in which a high-priority synchronization source is monitored may be configured as an anchor carrier. In the presence of carriers in which synchronization sources of the same priority are monitored, a carrier in which a synchronization source with a higher S-RSRP measurement is monitored may be configured as an anchor carrier. Alternatively, when carriers have already been prioritized, SLSS/PSBCH tracking may be performed first on a carrier with a high priority.

That is, the UE may monitor only a limited number of anchor carriers among the anchor carriers configured by the network according to the performance (e.g., UE capability) of the UE. Further, the UE may select a synchronization reference carrier by monitoring only some of the anchor carriers. These anchor carriers monitored by the UE may be referred to as an anchor carrier subset. As described above, the network may configure the monitoring priorities of anchor carriers and thus the anchor carrier subset may be determined accordingly. Alternatively, the anchor carrier subset may be determined according to carriers in which the UE simultaneously transmits or receives PSSCHs/PSCCHs (data/control signals), depending on UE implementation, or the SLSS/PSBCH reception/transmission capability of the UE. The UE may select one synchronization reference carrier (actual anchor carrier) from the anchor carrier subset.

In the present disclosure, an anchor carrier is a carrier from which a subframe boundary may be derived. Frequency synchronization as well as timing synchronization may be derived from the carrier. Frequency synchronization may be derived from an SL signal received in an individual carrier.

The network may configure a plurality of anchor carriers, and the UE may select a highest-priority synchronization source from among the anchor carriers. When carriers having the same priority are monitored, S-RSRPs may be measured in the carriers and a synchronization source and carrier with the largest S-RSRP may be selected. Herein, an anchor carrier may refer to a carrier in which an SLSS should be detected. While tracking (discovering) an SLSS in a CC indicated for SLSS detection, the UE may select a highest-priority synchronization source.

Whether the UE actually transmits an SLSS/PSBCH in a specific CC of which the timing has been derived from the anchor carrier may depend on whether the UE transmits a PSCCH/PSSCH. For example, the SLSS/PSBCH may be transmitted in the specific CC, when the network allows transmission of the SLSS/PSBCH in the CC, when the UE transmits the PSSCH/PSCCH transmission in the CC, or in a combination of both cases. In the case where the UE transmits the PSSCH/PSCCH while switching between multiple carriers with a limited transmission (Tx) chain, the UE may transmit the SLSS/PSBCH in all carriers carrying the PSCCH/PSSCH, only in a carrier with a high priority, or only in a carrier in which a high-priority synchronization source is monitored. When the UE transmits the SLSS/PSBCH simultaneously in different carriers, the UE should i) distribute transmission power to the multiple carriers, and ii) apply maximum power reduction (MPR). Therefore, the UE suffers power loss more than power distribution. Accordingly, it is preferable that the UE transmits the SLSS/PSBCH only in the carrier in which the highest-priority synchronization source is monitored (in a carrier selected as a synchronization reference carrier or an anchor carrier by the UE). In this case, a gain may be obtained in terms of transmission power.

In this method, however, for example, UE A transmits a synchronization signal only in a specific carrier (e.g., carrier X), and when another neighbor UE (e.g., UE B) selects a different carrier (e.g., carrier Y) as a synchronization reference, the synchronization signal from UE A may not be monitored in carrier Y. As a result, UE A and UE B do not acquire synchronization with each other. In order to solve the problem, the UE may need to transmit the SLSS/PSBCH in all carriers in which the UE has monitored synchronization signals.

A synchronization signal may always be transmitted in a carrier in which a synchronization source has been selected (it may be regulated that a synchronization signal is always transmitted in a carrier in which a synchronization source has been selected), while the synchronization signal may not be transmitted in all of the other carriers due to the limited Tx capability of the UE. In this case, the synchronization signal may be transmitted first in a carrier carrying the PSSCH/PSCCH. In this case, it may be regulated that the synchronization signal is transmitted necessarily in N synchronization resources appearing before the actual transmission of the PSSCH/PSCCH. This is intended to enable a receiving (Rx) UE to prepare for data signal reception with the right synchronization signal by transmitting the synchronization signal a certain number of times (e.g., N times) before data transmission. N may be predetermined or preconfigured, or configured by the network (e.g., BS).

When the Tx capability of the UE is extremely limited (e.g., when the number of Tx chains is limited to less than X), and when the UE transmits data or control signals while switching between multiple carriers, the UE may not transmit the synchronization signal each time even on the carrier with the selected synchronization source/reference. Particularly in intraband CA, when the UE always transmits the synchronization signal on a specific carrier, the UE should transmit the synchronization signal only on adjacent carriers, which restricts the operation of the UE. In this case, the rule that the SLSS/PSBCH is transmitted N or more times before PSSCH/PSCCH transmission may be commonly applied to a carrier in which a synchronization source/reference has been selected.

Alternatively, it may be regulated that Y % of synchronization signal transmissions are dropped on a carrier in which a synchronization source/reference has been selected, on a candidate carrier available as a synchronization reference carrier, or on a carrier allowed to carry the synchronization signal. The drop rate (e.g. Y) of synchronization signal transmissions may be set differently for each carrier. For example, Y1% SLSS/PSBCH dropping may be allowed for the carrier in which the synchronization source/reference has been selected, and Y2 SLSS/PSBCH dropping may be allowed for other carriers. Y1 and Y2 may be predetermined or preconfigured, or signaled by the network (e.g., BS). This method is intended to keep a synchronization operation as stable as possible on a specific carrier by allowing opportunistic dropping of SLSS/PSBCH transmissions on the specific carrier but at a smaller rate, when the Tx capability of the UE is limited. In the above embodiment, Y1 may be set less than Y2 to protect the carrier in which the synchronization source/reference has been selected, compared to the other carriers. When synchronization signal dropping is allowed on a carrier basis, a detailed dropping rule may depend on the implementation of the UE. Alternatively, when dropping is performed, an area in which dropping is prohibited may be set. For example, as mentioned above, it may be regulated that the SLSS/PSBCH is not dropped in synchronization resources before N synchronization resources before a subframe carrying the PSSCH/PSCCH or in synchronization resources before J subframes.

In intraband CA, the UE may simultaneously transmit a signal only in contiguous carriers. Otherwise (when the UE transmits a signal in non-contiguous carriers), the UE does not fully use transmission power due to high MPR. In this case, if the synchronization signal is always transmitted on a carrier in which a synchronization source/reference has been selected, the UE transmits the SLSS/PSBCH only on a carrier adjacent to the synchronization reference carrier due to its limited Tx capability. Therefore, the rule that a synchronization signal is always transmitted on a carrier in which a synchronization source has been selected may cause an inappropriate operation of the UE in some cases. Inappropriate means that the UE transmits the PSSCH/PSCCH, not the synchronization signal on some carrier. Therefore, to avoid this operation, the network should be able to configure the operation of transmitting a synchronization signal on a carrier in which a synchronization source has been selected, according to the UE capability under circumstances. For this purpose, it is proposed that the network signals whether a synchronization signal is always to be transmitted on a carrier in which a synchronization source has been selected.

In intraband CA, it may be regulated that that a UE does not select a synchronization reference/source in carriers configured at both ends among carriers in which the UE monitors a synchronization signal. This is because when a synchronization source is selected from a carrier located at an end in intraband CA, the synchronization signal will be transmitted only on a carrier adjacent to the carrier. Therefore, transmission of a synchronization signal in multiple carriers may be allowed by restricting selection of a synchronization source/reference only to a carrier located in the middle.

When all carriers in which the UE monitors a synchronization signal are the same, the UE may transmit a synchronization signal only on one of the carriers. This is because since all UEs will be monitoring the synchronization signal on the corresponding carrier, the UE may transmit the synchronization signal only on the specific carrier. Therefore, it may be regulated that a synchronization signal is transmitted on at least one of carriers among carriers configured for monitoring a synchronization signal by the network or configured as synchronization reference carriers. The synchronization signal may always be transmitted only on one carrier, or may be transmitted simultaneously on multiple carriers. This operation may depend on a configuration from the network or the UE may determine the number of carriers on which the synchronization signal is transmitted simultaneously.

When all carriers in which the UE monitors a synchronization signal are the same, the UE may perform synchronization selection by summing/averaging S-RSRPs measured in multiple carriers. Summation of S-RSRPs may be limited to a case of the same SLSS ID/PSBCH contents/PSSS/SSSS sequence. That is, since UEs selecting the same synchronization reference may transmit synchronization signals on different carriers, the UE sums synchronization signal measurements and evaluates the sum, for the same SLSS ID/PSBCH contents.

When the UE selects a synchronization source in a specific CC, the UE needs to determine which SLSS/PSBCH is transmitted in the CC and other CCs. The following methods may be considered.

The UE may transmit the SLSS/PSBCH only on a CC preconfigured (predetermined) or indicated for SLSS/PSBCH transmission by the network. This is done to obviate the need for transmitting the SLSS/PSBCH on a CC, in the absence of a Rel. 14 UE in the CC. (In any CC without a Rel. 14 UE, the SLSS/PSBCH is not transmitted, which may bring the effect of saving resources.)0

When the UE selects a synchronization source in a specific CC, the UE also transmits a synchronization signal and a PSBCH corresponding to a lower priority than that of the selected synchronization source on another CC. A synchronization signal offset indicator set for each CC or the selected CC may be used. This method is intended to maintain the existing operation as much as possible without changing the existing synchronization signal priority. The difference from the existing operation lies in that a subframe boundary is set based on a synchronization source selected in another CC, and the SLSS/PSBCH is transmitted on the CC accordingly.

It is proposed that when a UE selects a synchronization source in a specific CC, the UE transmits a synchronization signal and a PSBCH corresponding to the priority of a synchronization source selected in another CC. For example, when the network has configured two synchronization resources and the GNSS is selected as a synchronization source in CC #0, a legacy UE uses SLSS ID 0 and incoverage indicator=1, and a UE selecting the legacy UE as a synchronization source uses SLSS ID 0 and incoverage indicator=0. It is proposed that when transmitting a synchronization source in another CC, this UE uses incoverage indicator=1 instead of incoverage indicator=0 in this method. The UE may use SLSS ID=0 or a separate ID. The reason for using a separate ID is to eliminate ambiguity with a UE that has directly selected the GNSS as a sync source. However, since the ID has been derived from the same timing anyway, there may not be a big problem, and in that case, ID=0 may be used. If an ID other than ID=0 is used, the ID may be selected by the UE, predetermined, or configured by the network. For this purpose, a different synchronization resource offset indicator should be set for each CC. This operation may be selectively applied only to UEs that have selected the SLSS/PSBCH transmitted by the UE as a synchronization source, not applied to the top priority. For example, a UE that has directly selected the GNSS as a synchronization source also transmits an SLSS/PSBCH used when the GNSS has been selected as a synchronization source in another CC. Only when a certain UE selects an SLSS/PSBCH transmitted by a UE that has selected the GNSS as a synchronization source, the UE performs the above operation to prioritize synchronization sources that Rel. 15 UEs select in an anchor carrier.

This method is intended to make a synchronization source selected in a synchronization anchor carrier appear to have a higher priority in another carrier so that Rel. 14 UEs naturally connect to a synchronization source of an Rel. 15 UE.

The UE may signal to neighbor UEs a CC based on which the timing of a PSBCH has been derived. In this case, synchronization signals may not be SFNed because of different PBCHs for a Rel. 14 UE and a Rel. 15 UE. Therefore, the network may configure different synchronization sources for the releases. Alternatively, to enable SFN, the network may configure a reserved bit for the Rel. 14 UE to indicate an anchor carrier.

The contents of Table 2 to Table 6 below (see 3gpp RAN 92bis) may be used or referred to in implementing the embodiments of the present disclosure. Alternatively, the embodiments of the present disclosure may be implemented with the contents of Table 2 to Table 6 below.

TABLE 2
For UEs operating with CA

RAN1 assumes a UE may be configured a non-synchronization
carrier by defining the location of the SLSS resources and
by configuring the UE to not transmit SLSS on that carrier.

Rel. 14 RRC signalling is not sufficient.
Include an RRC parameter to introduce such mechanism.

A Rel.15 UE using the carrier without CA does not
apply this parameter
It is up to RAN2 to design the signalling to
support this feature

TABLE 3

The working assumption from RAN1#92 is confirmed with
following corrections

The UE is configured one of the following options based
on UE capability:

| 1. | SLSS is transmitted (based on Rel-14 procedure) |
|---|---|
| | on selected sync carrier from Set-B |
| 2. | SLSS is transmitted on all carriers from Set-B |

Each option is an independent UL capability
On top of this, Release-14 configuration applies to each
carrier individually

TABLE 4
For the case of limited TX capabilities, for UE SLSS transmission, it is up
to UE implementation on which synchronization carrier(s) from Set B UE
transmits SLSS

The above applies for the case when SLSS is transmitted on all
carriers from Set-B

TABLE 5
PSBCH content other than bandwidth, TDD configuration, reserved bits
are generated following the Rel. 14 procedure following the selected
synchronization reference.

Note if there is an issue with reserved bits, it will be addressed in
RAN1#93

SLSS ID is derived from the selected synchronization source.

TABLE 6
When synchronization is lost, synchronization carrier reselection is up to
UE implementation.

The network may configure synchronization carriers (Set-A), and the UE may monitor synchronization sources in some carriers (Set-B) at a specific time.

In relation to the foregoing Table 3 and Table 7, when the UE selects the GNSS or the BS (e.g., eNB or gNB) as a synchronization reference in a “selected sync carrier from Set-B”, the meaning of the “selected sync carrier” may be ambiguous.

TABLE 7
The UE is configured one of the following options based on UE capability:

SLSS is transmitted (based on Rel-14 procedure) on selected sync
carrier from Set-B

When the UE is configured with multiple anchor carriers (synchronization carriers), the UE may select the GNSS or the BS (e.g., eNB or gNB), although it may search for an SLSS in the (anchor) carriers. When selecting the GNSS or the BS, the meaning of the selected anchor carrier (or selected sync carrier) may be ambiguous. Moreover, ambiguity may also be involved in selecting a carrier in which the SLSS/PSBCH is to be transmitted. To eliminate the ambiguity, the present disclosure proposes a method of determining a carrier in which an SLSS/PSBCH is to be transmitted or a selected carrier, when a UE selects a GNSS or a BS (e.g., eNB or gNB) as a synchronization source/reference. The terms anchor carrier and sync carrier (synchronization carrier) are interchangeably used in the same meaning in the present disclosure.

Method 0) According to an embodiment of the present disclosure, a method of transmitting an SL channel/signal by a UE in a wireless communication system may include selecting a synchronization carrier and a synchronization reference, and transmitting an SL channel/signal based on the synchronization carrier. When the synchronization reference is a BS or a GNSS, the UE may select the synchronization carrier between a carrier for PSCCH transmission and a carrier for PSSCH transmission. The synchronization reference may be used for CA in UE-to-UE communication, and the SL channel/signal may include at least one of a PSCCH, a PSSCH, an SLSS, or a PSBCH. When the UE selects the BS (e.g., eNB or gNB) or the GNSS as the synchronization reference/source, the UE determines, as the selected synchronization carrier, a carrier carrying the PSCCH/PSSCH from among carriers (Set-B) in which the UE monitors an SLSS/PSBCH or configured potential synchronization carriers (Set-A). Therefore, a mobile communication system according to the present disclosure provides the technical effect of preventing an operation triggering unnecessary RF switching, caused by different carriers for synchronization signal transmission and PSSCH/PSCCH transmission.

The selection of a synchronization carrier may include selecting, as the synchronization carrier, one carrier (frequency) out of the carrier(s) for the PSCCH transmission and the carrier(s) for the PSSCH transmission (by the UE), among carrier(s) corresponding to at least one combination of i) a plurality of carriers configured as potential synchronization carriers for CA by the BS, ii) a carrier in which the UE transmits (or monitor) an SLSS, iii) a carrier in which the UE transmits (or monitors) a PSBCH, and iv) carriers in which the UE performs the CA.

For example, the following operation may be performed. The BS may configure potential carriers available as a synchronization carrier for CA. These carriers may be referred to as Set-A (or a first set). In the presence of carrier(s) that the UE actually uses for CA, carrier(s) used for CA among the carriers of Set-A may be referred to as Set-B (or a second set). That is, Set-B may be a subset of Set-A. Configuration information about Set-A may be transmitted by higher-layer signaling (e.g., RRC signaling) from the BS. For example, the BS may configure carrier #0 to carrier #5 as potential carriers available as a synchronization carrier for CA. When the UE actually uses carrier #4, carrier #5, and carrier #6 for CA, the intersection between carrier #0 to carrier #5 and carrier #4 to carrier #6, that is, carrier #4 and carrier #5 may be referred to as Set-B (the second set). In this case, the UE may select (at least) one of carrier #4 and carrier #5 as the synchronization carrier. Specifically, the UE may select carrier(s) for PSCCH transmission or carrier(s) for PSSCH transmission between carrier #4 and carrier #5, and select one of the carrier(s) as the synchronization carrier.

Additionally, when there are a plurality of carriers for PSCCH transmission or PSSCH transmission, the UE may select one of the carriers (frequencies) as the synchronization carrier. The synchronization carrier may be selected arbitrarily by the UE or depending on implementation of the UE. When the UE transmits the PSCCH/PSSCH on multiple carriers, the UE may select any of the carriers or a carrier depending on UE implementation as the selected synchronization carrier.

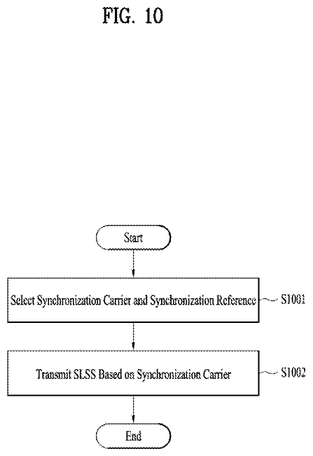

FIG. 10 is a flowchart illustrating an operation of a UE in relation to an embodiment of the disclosure. The UE may perform operation S1001 and then operation S1002. However, the flowchart does not mean that the UE should perform all of the operations or only the operations.

Operation S1001 may be related to the foregoing description, for example, the selection of a synchronization carrier and a synchronization reference at the UE. For details, refer to the foregoing related description. Operation S1002 may be related to the foregoing description, for example, the transmission of a sidelink channel/signal based on the synchronization carrier at the UE. For details, refer to the foregoing related description.

In other words, according to an embodiment of the present disclosure, a method of transmitting an SL channel/signal by a first UE in a wireless communication system may include selecting a synchronization carrier and a synchronization reference (S1001) and transmitting an SL channel/signal based on the synchronization carrier (S1002). When the synchronization reference is a BS or a GNSS, the UE may select the synchronization carrier between a carrier for PSCCH transmission and a carrier for PSSCH transmission. The SL channel/signal may include at least one of a PSCCH, a PSSCH, an SLSS, or a PSBCH. The selection of a synchronization carrier at the UE (S1001) may include selecting the synchronization carrier randomly or according to implementation of the UE from among a plurality of carriers for PSCCH transmission or a plurality of carriers for PSSCH transmission. Further, the selection of a synchronization carrier at the UE (S1001) may include selecting a carrier for the PSCCH transmission or a carrier for the PSSCH transmission as the synchronization carrier based on at least one combination of a plurality of carriers configured as potential synchronization carriers for CA by the BS, a carrier in which the UE monitors an SLSS, a carrier in which the UE monitors a PSBCH, and a carrier in which the UE performs the CA.

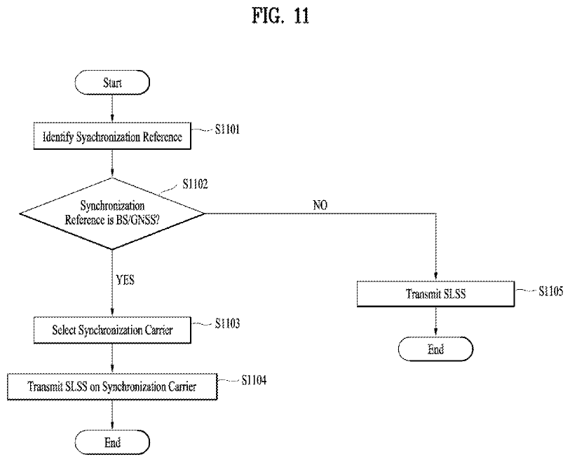

FIG. 11 is a flowchart illustrating an operation of a UE in relation to an embodiment of the disclosure. The UE may perform operations S1101 and S1102 and then operations S1103 and S1104 or operation S1105. However, the flowchart does not mean that the UE should perform all of the operations or only the operations.

Operations S1101 and S1102 may be related to the foregoing description, for example, the identifying of a synchronization reference at the UE. For details, refer to the foregoing related description. When the synchronization reference is identified as a BS or a GNSS, the UE performs operations S1103 and S1104. For details, refer to the foregoing related description. When the synchronization reference is identified as a network entity (e.g., SyncRef UE) other than the BS and the GNSS, the UE performs operation S1105. Operation S1105, that is, transmission of an SLSS may be based on a legacy SL channel/signal transmission procedure, an SL channel/signal transmission procedure defined in standards (e.g., the 3GPP standards) when the synchronization reference is a UE, or a procedure of transmitting an SL channel/signal on a selected synchronization carrier as in operations S1103 and S1104.

Method 1) The synchronization carrier may be selected based on the indexes of a plurality of carriers. For example, a carrier with the lowest index may be selected as the synchronization carrier. When the UE selects the BS (e.g., eNB or gNB) or the GNSS as a synchronization reference/source, for example, the UE may consider a carrier with the lowest (or highest) of the indexes of carriers (Set-B) in which the UE has monitored an SLSS/PSBCH or configured potential synchronization carriers (Set-A) to be the selected carrier. In another example, the UE may identify a carrier predetermined from among the carriers of Set-A and/or Set-B as the selected carrier.

For example, the following operation may be performed. The BS may configure potential carriers available as a synchronization carrier for CA. These carriers may be referred to as Set-A (or a first set). In the presence of carrier(s) that the UE actually uses for CA, carrier(s) used for CA among the carriers of Set-A may be referred to as Set-B (or a second set). That is, Set-B may be a subset of Set-A. Configuration information about Set-A may be transmitted by higher-layer signaling (e.g., RRC signaling) from the BS. For example, the BS may configure carrier #0 to carrier #5 as potential carriers available as a synchronization carrier for CA. When the UE actually uses carrier #4, carrier #5, and carrier #6 for CA, the intersection between carrier #0 to carrier #5 and carrier #4 to carrier #6, that is, carrier #4 and carrier #5 may be referred to as Set-B (the second set). In this case, the UE may select carrier #4 with the lower index (or carrier #5 with the higher index) between carrier #4 and carrier #5 as the synchronization carrier. This method may offer the technical effect of extending the coverage of a synchronization signal by, when a UE selects a GNSS or a BS (e.g., eNB or gNB) as a synchronization reference, considering all UEs as selecting the same carrier and thus allowing a large number of UEs to transmit SLSSs/PSBCHs.

Further, this method may provide an improved wireless communication system because additional signaling is not required.

However, in the case where a specific carrier of Set-B is considered to be the selected carrier, when each UE selects the GNSS/BS, selected carriers may be distributed. Set-B may be carriers in which an SLSS/PSBCH is monitored.

With reference to FIG. 10, method 1) will be described below. The UE may perform operation S1001 and then operation S1002. According to an embodiment of the present disclosure, a method of transmitting an SL channel/signal by a first UE in a wireless communication system may include selecting a synchronization carrier and a synchronization reference (S1001) and transmitting an SL channel/signal based on the synchronization carrier (S1002). When the synchronization reference is a BS or a GNSS, the UE may select the synchronization carrier between a carrier for PSCCH transmission and a carrier for PSSCH transmission. The SL channel/signal may include at least one of a PSCCH, a PSSCH, an SLSS, or a PSBCH. The selection of selecting a synchronization carrier and a synchronization reference (S1001) may include selecting the synchronization carrier based on the indexes of a plurality of carriers. Specifically, the selection of selecting a synchronization carrier and a synchronization reference (S1001) may include selecting a carrier with the lowest index as the synchronization carrier.

Method 2) It is proposed that when the UE selects the BS (e.g., eNB or gNB) or the GNSS as a synchronization reference/source, the network signals a carrier that the UE is supposed to regard as a selected carrier by physical-layer signaling or higher-layer signaling. When the synchronization reference is the BS (e.g., eNB or gNB) or another network entity (e.g., GNSS), the UE may select the synchronization carrier based on the physical-layer signaling or higher-layer signaling from the BS.

According to this method, the network may flexibly determine a carrier in which UEs selecting the GNSS/BS as a synchronization reference will transmit SLSSs/PSCHs, and may operate a plurality of such carriers, when needed. The BS may transmit information indicating at least one frequency resource (e.g., carrier) used for the UE to transmit an SLSS and/or a PSBCH to the UE by physical-layer signaling or higher-layer signaling (e.g., RRC signaling).

When the synchronization reference is the BS (e.g., eNB or gNB) or another network entity (e.g., GNSS), the UE may select the synchronization carrier in consideration of the capability of the UE. When the UE selects the GNSS/BS according to its UE capability, the UE may select a different carrier as the selected synchronization carrier, and the network may configure different selected synchronization carriers according to UE capabilities. The BS may select a network entity (e.g., GNSS or BS) based on the capability of the UE or select a frequency resource (e.g., carrier) related to synchronization, and transmit information indicating the selected network entity or the frequency resource related to the synchronization to the UE by physical-layer signaling or higher-layer signaling (e.g., RRC signaling). The BS may configure different frequency resources for each of a plurality of UEs in consideration of the capability of the individual UE.

When the GNSS or the BS (e.g., eNB or gNB) is selected as the synchronization reference/source, the UE may determine a selected synchronization carrier to carry an SLS/PSBCH in the proposed method.

Different synchronization carriers may be configured when the GNSS is selected and when the BS (e.g., eNB or gNB) is selected. The selected synchronization carriers may be different when the GNSS is selected as the synchronization reference/source and when the BS (e.g., eNB or gNB) is selected as the synchronization reference/source. This configuration is made for the purpose of avoiding mutual destructive interference between a UE selecting the BS as a synchronization reference and a UE selecting the GNSS as a synchronization reference by making the UEs transmit SLSSs/PSBCHs on different carriers. The mobile communication system according to the present disclosure may expect the effect of reducing interference that may occur during SLSS/PSBCH transmission according to this method.

The following will be described in relation to a method of configuring a different synchronization resource (synchronization source) for each CC among the above methods. The network may configure the same synchronization resource (synchronization source) for each CC for some reason. Particularly in intraband CA, transmission of a synchronization signal on a specific CC may make reception in other subframes impossible. Then, sensing (or reception) may also be impossible in subframes of another CC overlapping with synchronization subframes of each CC, and thus transmission may not be performed. To avert the problem, the network may align synchronization resources (synchronization sources) between group CCs (or carrier groups). In this case, the resulting reduction of transmission power of a synchronization signal in each CC may cause reduction of synchronization coverage. The following method may be considered to solve the problem.

It is proposed that when synchronization resources (synchronization sources) are aligned between CCs, a different synchronization signal/different PSBCH transmission power is configured for each CC. This is done to prevent excessive reduction of synchronization coverage in a specific CC by increasing transmission power in the CC. For example, high SLSS/PSBCH transmission power may be configured for a CC expected to have a Rel. 14 UE or a synchronization anchor CC. For this purpose, the network may signal to the UE information indicating how much SLSS/PSBCH transmission power should be configured for which CC by physical-layer signaling or higher-layer signaling. This information may be represented as an offset. This configuration may be preconfigured or predetermined by the network or the UE. Further, the BS may transmit power information corresponding to each frequency resource (e.g., CC) to the UE by physical-layer signaling or higher-layer signaling.

When the network configures the same synchronization resource (synchronization source) for CCs, an Rx UE may (re)select a synchronization source based on the sum/maximum/minimum/average of S-RSRP measurements of the CCs. This method brings the technical effect of extending effective synchronization coverage by summing measurements, on the assumption that the same synchronization signal is transmitted distributed to multiple CCs.

The present disclosure is not limited to D2D communication. That is, the disclosure may be applied to UL or DL communication, and in this case, the proposed methods may be used by a BS, a relay node, etc.

Since each of the examples of the proposed methods may be included as one method for implementing the present disclosure, it is apparent that each example may be regarded as a proposed method. Although the proposed methods may be implemented independently, some of the proposed methods may be combined (or merged) for implementation. In addition, it may be regulated that information on whether the proposed methods are applied (or information on rules related to the proposed methods) should be transmitted from a BS to a UE or from a transmitting UE to a receiving UE through a predefined signal (e.g., a physical layer signal, a higher layer signal, etc.).

Device Configurations According to Embodiments of the Present Disclosure

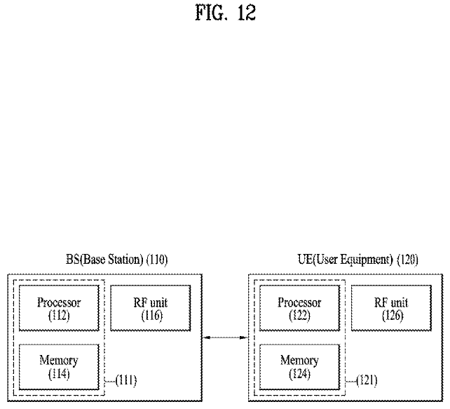

Referring to FIG. 12, a wireless communication system includes a BS device 110 and a UE device 120. When the wireless communication system includes a relay, the BS or UE may be replaced with the relay.

The BS device 110 may include a processor 112, a memory 114, and a radio frequency (RF) unit 116. The processor 112 may be configured to perform the described/proposed procedures and methods by controlling the memory 114 and/or the RF unit 116. For example, the processor 112 may generate first information and/or a first signal by processing information in the memory 114 and then control the RF unit 116 to transmit a radio signal containing the first information/signal. The processor 112 may control the RF unit 116 to receive a radio signal containing second information and/or a second signal and then control the memory 114 to store information obtained by processing the second information/signal. The processor 112 may include a communication modem designed suitable for a wireless communication technology (e.g., LTE, NR, etc.). The memory 114 may be connected to the processor 112 and configured to store various information on the operations of the processor 112. For example, the memory 114 may store software code including commands for performing some or all of the processes controlled by the processor 112 or the described/proposed procedures and methods. The RF unit 116 may be connected to the processor 112 and configured to transmit and/or receive a radio signal. The RF unit 116 may include a transmitter and/or a receiver. The RF unit 116 may be replaced with a transceiver. The processor 112 and the memory 114 may be included in a processing chip 111 (e.g., system on chip (SOC)).

The UE device 120 may include a processor 122, a memory 124, and an RF unit 126. The processor 122 may be configured to perform the described/proposed procedures and methods by controlling the memory 124 and/or the RF unit 126. For example, the processor 122 may generate third information or a third signal by processing information in the memory 124 and then control the RF unit 126 to transmit a radio signal containing the third information/signal. The processor 122 may control the RF unit 126 to receive a radio signal containing fourth information or a fourth signal and then control the memory 124 to store information obtained by processing the fourth information/signal. For example, the processor 112 may be configured to determine the transmission power of a sidelink packet for each of a plurality of carriers and transmit a sidelink signal on at least one carrier among the plurality of carriers based on the determined transmission power. The transmission power may be determined based on priorities of sidelink packets scheduled to be respectively transmitted on the plurality of carriers, the sum of transmission powers of the sidelink packets scheduled to be respectively transmitted on the plurality of carriers, and the maximum transmission power of the UE.

The processor 122 may include a communication modem designed suitable for a wireless communication technology (e.g., LTE, NR, etc.). The memory 124 may be connected to the processor 122 and configured to store various information on the operations of the processor 122. For example, the memory 124 may store software code including commands for performing some or all of the processes controlled by the processor 122 or the described/proposed procedures and methods. The RF unit 126 may be connected to the processor 122 and configured to transmit and/or receive a radio signal. The RF unit 126 may include a transmitter and/or a receiver. The RF unit 126 may be replaced with a transceiver. The processor 122 and the memory 124 may be included in a processing chip 121 (e.g., SOC).

The above-described device may be replaced with a network node, a transmitting UE, a receiving UE, a wireless communication device, a vehicle, an autonomous driving vehicle, a drone (unmanned aerial vehicle (UAV)), an artificial intelligence (AI) module, a robot, an augmented reality (AR) device, a virtual reality (VR) device, etc. For example, the UE may include a mobile phone, a smartphone, a laptop computer, a digital broadcast terminal, a personal digital assistant (PDA), a portable multimedia player (PMP), a navigation device, a slate personal computer (PC), a tablet PC, an ultrabook, a wearable device (e.g., a smartwatch, a smart glass, a head mounted display (HMD), etc.), etc. For example, the drone may be a flying object controlled by radio control signals without a human pilot. For example, the HMD may be a display device worn on the head of a user. The HMD may be used to realize VR or AR.

The embodiments of the present disclosure described hereinbelow are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the embodiments of the present disclosure, a description is made centering on a data transmission and reception relationship among a BS, a relay, and an MS. In some cases, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc. The term WE′ may be replaced with the term ‘Mobile Station (MS)’, ‘Mobile Subscriber Station (MSS)’, ‘mobile terminal’, etc.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memory unit is located at the interior or exterior of the processor and may transmit and receive data to and from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure may be used for a UE, a BS, a relay, or other equipment in a wireless mobile communication system.

1. A method of transmitting a sidelink synchronization signal by a user equipment (UE) in a wireless communication system, the method comprising:
selecting a synchronization carrier and a synchronization reference; and
transmitting a sidelink synchronization signal based on the synchronization carrier,
wherein when the synchronization reference is a base station (BS) or a global navigation satellite system (GNSS), the UE selects the synchronization carrier between a carrier for physical sidelink control channel (PSCCH) transmission and a carrier for physical sidelink shared channel (PSSCH) transmission.

2. The method according to claim 1, wherein the selection of a synchronization carrier and a synchronization reference comprises selecting the synchronization carrier from among a plurality of carriers for PSCCH transmission or a plurality of carriers for PSSCH transmission by the UE, randomly or according to implementation of the UE.

3. The method according to claim 1, wherein the selection of a synchronization carrier and a synchronization reference comprises selecting the synchronization carrier between the carrier for PSCCH transmission and the carrier for PSSCH transmission by the UE, based on at least one combination of a plurality of carriers configured as potential synchronization carrier for carrier aggregation (CA) by a BS, a carrier in which a sidelink synchronization signal is monitored by the UE, a carrier in which a physical sidelink broadcast channel (PSBCH) is monitored by the UE, and a carrier in which the UE performs the CA.

4. The method according to claim 1, wherein the selection of a synchronization carrier and a synchronization reference comprises selecting the synchronization carrier based on indexes of a plurality of carriers.

5. The method according to claim 4, wherein the selection of the synchronization carrier comprises selecting a carrier having a lowest index as the synchronization carrier.

6. The method according to claim 1, wherein the selection of a synchronization carrier and a synchronization reference comprises selecting the synchronization carrier based on physical-layer signaling or higher-layer signaling from a BS.

7. The method according to claim 1, wherein the selection of a synchronization carrier and a synchronization reference comprises selecting the synchronization carrier in consideration of a capability of the UE.

8. The method according to claim 1, wherein the selection of a synchronization carrier and a synchronization reference comprises:
when the synchronization reference is the BS, selecting a first carrier as the synchronization carrier; and
when the synchronization reference is the GNSS, selecting a second carrier as the synchronization carrier.

9. The method according to claim 1, wherein the synchronization reference is for CA in UE-to-UE communication.

10. A user equipment (UE) for transmitting a sidelink synchronization signal in a wireless communication system, the UE comprising:
a transceiver; and
a processor,
wherein the processor is configured to control the transceiver, select a synchronization carrier and a synchronization reference, and transmit a sidelink synchronization signal based on the synchronization carrier, and
wherein when the synchronization reference is a base station (BS) or a global navigation satellite system (GNSS), the UE selects the synchronization carrier between a carrier for physical sidelink control channel (PSCCH) transmission and a carrier for physical sidelink shared channel (PSSCH) transmission.

11. The UE according to claim 10, wherein the UE communicates with at least one of a mobile terminal, a network, or an autonomous driving vehicle other than the UE.

12. The UE according to claim 10, wherein the UE executes at least one advanced driver assistance system (ADAS) function based on a signal for controlling movement of the UE.

13. The UE according to claim 10, wherein the UE receives a user input and switches a driving mode of the UE from an autonomous driving mode to a manual driving mode or from the manual driving mode to the autonomous driving mode according to the user input.

14. The UE according to claim 10, wherein the UE autonomously drives based on external object information, and
wherein the external object information includes at least one of information about the presence or absence of an object, information about a position of the object, information about a distance between the UE and the object, or information about a relative speed between the UE and the object.
